(19) United States
(12) Patent Application Publication
(10) Pub. No.: US 2002/0129279 A1
(43) Pub. Date: Sep. 12, 2002

(54) Methods and apparatus usable with or applicable to the use of the internet

(76) Inventor: Simon Alan Spacey, London (GB)

Correspondence Address: Simon Spacey, 2 Lansdowne Row Suite 94, London, W156HL, GB

(21) Appl. No.: 09/869,311

(22) PCT Filed: Apr. 4, 2001
(86) PCT No.: PCT/GB01/01539

(30) Foreign Application Priority Data
Apr. 4, 2000 (GB) 0008276.8

(51) Int. Cl. H04L 9/00

(52) U.S. Cl. 713/201

(57) ABSTRACT

A method affording privacy or anonymity on an Internet-type or other communications medium. The method affords users with standard client applications and network components privacy and anonymity by routing application requests and responses through a secure connection with a special intermediary machine. The intermediary machine is preferably on a different network segment to the client (for example on the Internet). The secure client-intermediary connection prevents “sniffers” watching the client from seeing the contents of client request and responses even where the true destination service site is not capable of secure communications itself and the intermediary-service site connection is insecure. Clients requests may be specially formatted so that they can be routed by the standard client applications to the intermediary instead of going directly to the true service site. The intermediary listens for and then transforms these specially formatted requests into requests routable to the true destination service site and sends the requests formatted as if they originated from a client located on the intermediary machine itself. Service machines thus return responses to the intermediary thinking it is a client and the intermediary transforms and securely forwards these responses on to the true client ensuring its anonymity and communication security.

### BACKGROUND

This invention relates to methods and apparatus affording user security, privacy and anonymity on a communications channel such as telephone, WAP or the Internet and World Wide Web.

Many communications technologies work on a point-to-point or client-server basis. A general communications protocol involves 3 steps:

1) A client locates a server address on a communications medium.

2) The client sends a formatted request to the server address.

3) The server listens for client requests, receives and interprets them and then returns a response to the client's address.

There are at least two security issues with this standard process. First, the server needs to know the client's true address on the communications medium so that it can return a response to it. This means that clients do not have anonymity when asking for services and this may represent an unwanted breach of some users' privacy. The second issue is that the communications are usually transmitted through the medium in an unencrypted format. While this makes the client and server processes simpler, it further reduces client privacy and allows communications to be “sniffed”. This is one of the main reasons for Cyber-Crime on the Internet. These same anonymity and security issues occur across application communication protocols as varied as HTTP (Hyper-Text Transfer Protocol), SMTP and POP (e-mail protocols), FTP and WAP.

On the Internet, users privacy is further compromised by Internet Service Providers (ISPs) who often log the Web Servers and URLs a user visits. These logs are in addition to history files and cookies kept locally on the user's workstation or PC and many users may object to this logging as a breach of their privacy if they knew it happened. Destination logs can be taken because the client contacts the destination address directly (through the dial-up ISP) even if it then proceeds to set-up a secure communication link to that direct service address.

By introducing a secure intermediary that acts as a proxy between the client and server, the present invention removes many of the privacy and security issues associated with current communications technologies. The invention uses special address transformations to make existing applications communicate securely through the intermediary without requiring client or network re-configuration and to prevent ISP address logging.

### BRIEF SUMMARY OF THE INVENTION

It is a general object of the present invention to provide methods and apparatus capable of affording security, privacy and anonymity on a communications channel such as the Internet. It is also an object of the present invention to provide such methods and apparatus that are compatible with most existing Internet applications including existing Web browsers and work seamlessly with them.

According to an aspect of the invention there is provided a method of using the Internet which actively prevents any logging by Internet servers, providers, routers and other machines associated therewith of details of destination sites visited by a user or client and preferably, at least, hinders Internet Transaction ‘sniffing’ on insecure Internet transactions. The method also protects the anonymity of Internet users.

The method may involve a user/client establishing, preferably through an Internet provider, a connection with an intervening or intermediary site, the intermediary site then provides access to destination sites for the client without the destination sites being logged as having been accessed directly by the client. The only Internet activity of the client that can be logged by any Internet servers, providers, routers and other machines associated therewith is the access to the intermediary site by the client. By using an intermediary site, the method additionally prevents logging by the end destination sites of information as to the identity of the client.

Further, the connection between the client and the intermediary site is preferably a secure, encrypted connection to hinder Transaction ‘Sniffing’ and further facilitate client Internet privacy. The client to intermediary site connection is preferably secure even if the corresponding client to end destination site would otherwise not be capable of a secure connection. Such a secure connection ensures encryption protection of user requests and responses, information sent through the Internet by the user (this includes the URL of the real destination site the user accesses) and information sent back to users. An example of an encrypted connection is a Secure Socket Layer (SSL) connection. SSL connections provide a public-key encryption framework widely considered to be suitable for commercial exchange and data transferral and are considered secure. SSL encryption capabilities are built in to many Web browser clients today. Using SSL, web browser requests are sent to the intermediary server using HTTP (Secure Hyper-Text Transfer Protocol) instead of standard HTTP and these requests are transformed and passed on to the destination server using either standard HTTP or HTTPS depending on the secure capabilities of the final destination Web Server.

Preferably in the method of the invention:

1) A client establishes a secure connection with an intermediary site;

2) The client uses the secure connection to send a request for a destination site through the intermediary site;

3) The intermediary site transforms the request into a standard Internet request containing only selected information as to the direct identity of the client;

4) The intermediary site sends the Internet request to the destination site;

5) The destination site returns the requested response to the intermediary site;

6) The intermediary site transforms the response, and preferably any further links or references therein, into a response identified as being from the intermediary site; and

7) The intermediary site, using the secure connection, sends the response back to the client.

The user can read and process the returned destination site information normally and then make a request for another destination site item. To do this the user can simply enter another URL constructed in such a way that it is interpreted through the intermediary site. However, in the case of a Web browser, the user may wish to click on a hypertext link within a viewed web page. Thus, in a practical implementation of the method of the invention, as well as transforming the response into a response identified as being from the intermediary site, the intermediary site finds any references (links or other items) that refer to destination sites on the Internet; and transforms these references so that any future request made by the client using these references is made through the intermediary site. Thus the Web browser client can use the Internet securely, privately and anonymously through the, preferably secure, intermediary server by either inputting URLs directly or by clicking transformed links on web pages in a browser in the normal way to select destination sites through the intermediary server. This transformation process means that Web browsers do not need any configuration changes (such as setting their proxy server to the intermediary server), or any additional software in order for their communications to be ‘locked’ through the, preferably secure, intermediary server.

Client programs use ports/sockets to connect to server programs on the Internet. Port numbers range from 0 to 65535 with numbers 0 to 1023 used for standard services, for example number 80 is used as the default for HTTP and number 443 for HTTP Web Servers. These defaults do not have to be used and preferably in the method of the present invention non-standard port numbers, i.e. above 1023, are used when establishing connection with the intermediary site. This allows clients to use communications, particularly SSL communications, through existing company or cyber-café firewalls without any reconfiguration. Internet firewalls often stop SSL communications within the standard 0 to 1023 range and are effectively bypassed by using these non-standard port numbers allowing a method, in accordance with the invention, to be used with a variety of firewalls. A method to bypass Internet firewalls using Internet port numbers above 1023 as listening ports on the intermediary is therefore provided.

Another aspect of the invention provides a method for preventing “Denial of Service attacks” on the intermediary and destination Internet Sites. These attacks are often caused where a malicious client application repeatedly and rapidly sends requests to a destination site but does not wait for the responses. By doing this, the destination site is slowed down because it is continually sending a large number of (potentially large) Internet responses to the malicious client and has no time to service other client's requests. By keeping track of whether clients wait to receive the responses to their requests or not the intermediary server can address these “Denial of Service attacks”. Preferably the method comprises holding back the passing on of client requests to the destination site by some period of time, the length of which is related to the number of times the client has not been present to receive responses for the requests it has sent in the past.

Another aspect of the invention provides a method of sending or receiving an e-mail which actively prevents any logging by Internet servers, providers, routers and other machines associated therewith of details of the destination of the e-mail or its contents. The method may involve the client establishing preferably through an Internet provider a secure, encrypted connection with an intermediary site and sending or receiving an e-mail through the intermediary site. The only activity of the client that can be logged by any Internet servers, providers, routers and other associated machines is the access to the intermediary site by the client.

Another aspect of the invention provides a method of securely storing files on the Internet. The method comprises the client establishing preferably through an Internet provider a secure, encrypted connection with a file storage site through the intermediary server, the client sending a file to the site through the secure connection with the intermediary server and the site storing the file. In the preferred implementation of this method, the intermediary site offers the services of the file storage site itself for the user—removing the need for a second machine and second file transfer. The client can then securely save and retrieve the files by connecting to the secure intermediary site at any time.

According to another aspect of the invention there is provided a method of establishing Internet communication between a client and any normal Internet destination site by initiating a request containing address information and interposing an intervening site between the client and the destination site, the intervening site acting to ensure that the only recordable information concerning the identities of both the client and destination site is held by the intervening site.

Another aspect of the invention provides a method affording privacy and anonymity on the Internet, the method comprising:

1) A client establishing a secure connection with an intermediary site;

2) The intermediary site offering a range of services to the client; and

3) The client selecting a service.

The services may include using existing external (normal) Internet sites and services while any logging of details of destination sites visited or contents of Internet transactions is actively prevented by the secure layer and the intermediate server, sending or receiving e-mail while any concurrent logging of the destination/source or contents of the e-mail is actively prevented, and/or storing files securely on the intermediary site. The secure connection established between the client and intermediary site provides communication privacy over the intermediary site's services.

Another aspect of the invention provides a method of establishing an Internet or other communications link between a client or user site and a destination site for the passage of information therebetween. The method is characterised by interposing an intermediary site between the client or user site and the destination site. The intermediary site acts as a virtual (and preferably secure) destination site for the client or user site and as a virtual client or user site for the destination site. This is to the extent that all logging entries on the destination site only show the intermediary site as the client or user and all logging entries on the client or user site only show the intermediary site as the destination site.

The methods described herein can improve efficiency and speed of Communication transactions. This can be by the use of compression and other methods. Compression is particularly important for increasing the efficiency of the client connection to the Internet as this is usually relatively slow. Thus the introduction of an intermediary server that compresses transactions as they pass to and from the client is another aspect of the invention. This can be achieved by using compressed SSL communications where the client would otherwise use uncompressed Internet connections.

According to another aspect of the invention there is provided apparatus for performing any one or more of the methods of the invention. Preferably the apparatus comprises a server connected or connectable to the Internet, the server having means to allow a client to establish a secure connection with the server. The server may comprise means to perform any of the steps of any of the methods described herein.

### BRIEF DESCRIPTION OF THE DRAWINGS

Implementations and embodiments of the invention will be described, by way of example only, with reference to the accompanying drawings, in which:

FIG. 1 is a flow chart illustrating the implementation of a method of the invention;

FIG. 2 is a flow chart illustrating a general transformation procedure used in the implementation of a method of the invention; and

FIG. 3 is a block diagram illustrating an embodiment of the apparatus of the invention in use.

### DETAILED DESCRIPTION OF THE INVENTION

The invention may be understood more readily and various other aspects and features of the invention may become apparent from consideration of the following description taken from the field of Internet communication.

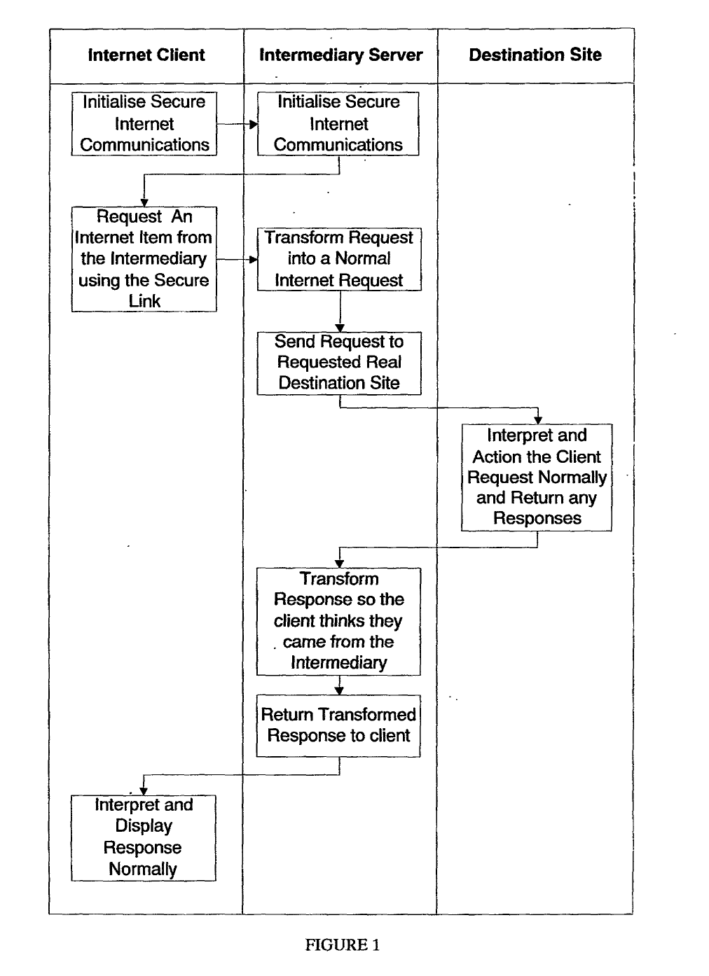

FIG. 1 shows the steps taken by an Internet client, an intermediary site and a destination site. A secure Internet connection or link is established between the Internet client and the intermediary site by the Internet client and the intermediary site initialising a secure Internet communication. In the case of a Web Browser client, a HTTPS connection provides this secure link. The Internet client, using the secure link, requests an Internet item from the intermediary site. A common example of an Internet item is a normal insecure web page from a destination site. The intermediary site transforms the request into a normal Internet request suitable for the destination site to understand—such as a HTTP or HTTPS request in the case where the destination is a normal Web Server. The normal Internet request, since it is sent by the intermediary site, contains information concerning the identity of the intermediary site and no information or only limited information concerning the identity of the real Internet client. The intermediary site sends the normal Internet request to the destination site containing the Internet item. The destination site interprets and actions the request normally and returns any response to the intermediary site as the site that requested the item. The intermediary site transforms the response to be identified as originating from the request sent to the intermediary site and using the secure link returns the transformed response to the client. The client interprets and displays the response normally. The client can use a similar secure link to make subsequent requests that are similarly processed. The only information relating to Internet activity that can be logged or monitored by a local server or ISP is the accessing of the intermediary site by the client. Importantly, since the client communicates with the intermediary site over a secure link, it is not possible for any Internet servers or the client's ISP to monitor the Internet transaction's contents or even to log the final destination URL the client requested (securely) from the intermediary site.

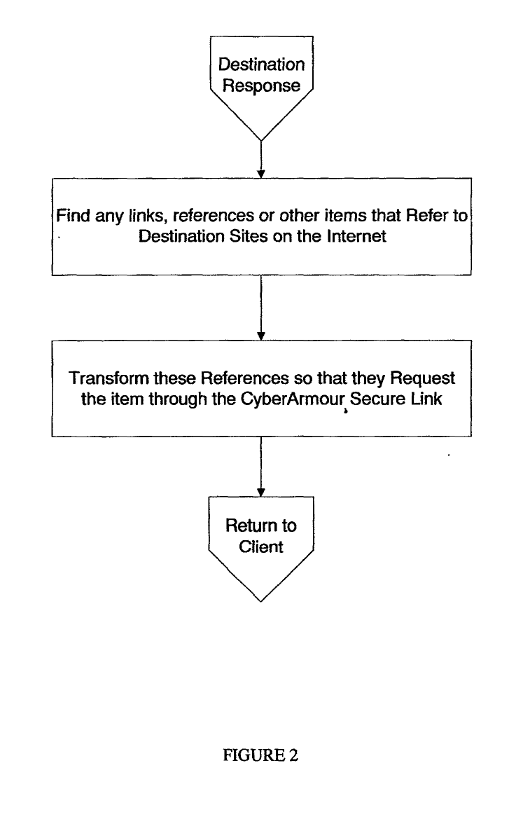

As well as transforming the response to be identified as originating from the request sent to the intermediary site, the intermediary site performs additional response transformations to Internet items returned from the destination site. The additional response transformations are both client specific and implementation specific and indeed may not be required in some instances and for some application protocols. FIG. 2 illustrates an example additional transformation procedure. The intermediary site locates any links, references or other items that refer to real Internet sites and transforms these so that any requests made for these links are requested via the intermediary site. The intermediary site then returns the transformed response to the Internet client. This ‘locks’ future requests through the (preferably secure) intermediary site without the need for client re-configuration or additional client software components. For example, a Web Browser user can click on a hypertext link within a viewed web page to access a separate web page. The web page is accessed through the intermediary site (following the steps of the method described with reference to FIG. 1) rather than directly because the link has been transformed. Direct access, through an untransformed link, would result in the link to the Internet via the intermediary site being broken and normal web access resuming which could be logged or monitored by Internet servers or the user's ISP.

A specific potential transformation of part of a Web site's response is shown below for illustration purposes. A response returned by the destination site to the intermediary site, www.cyberarmour.com, defines a link to another web site, wvww.gkn.net. The corresponding HTML code segment containing the response is: <A HREF=”http://www.gkn.net”>

This line of HTML code is located and transformed to:

<A HREF=”https://www.cvberarmour.com:2030/Encrypted:www.gkn.net”>

All other references, links and other Internet items would be similarly changed before the response is returned to the client. The word “Encrypted:” and the “:2030” port number are implementation dependent and could be omitted or changed. The non-standard port number of 2030 has been included here to by-pass Internet firewalls and consequently avoids any potential need for client or firewall reconfiguration. This example transformation is constructed to ensure that when the user clicks on the link generated from the code segment, a request is sent through a secure connection (https://) to the intermediary server (www.cyberarmour.com) bypassing any firewalls (2030) and requests from the intermediary server the normal HTTP (Encrypted:) Web Server item ‘www.gkn.net’.

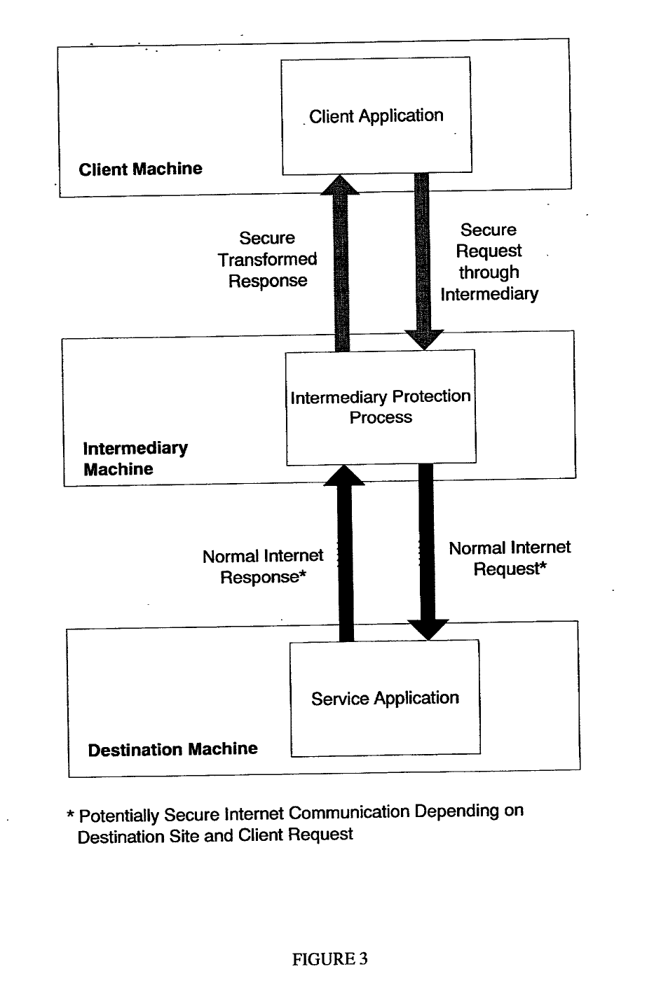

A preferred embodiment/implementation, shown in FIG. 3, requires no change to the client or destination server components. This implementation is suitable for client applications that have existing secure communication capabilities such as most Internet/Web Browsers. The client application connects securely to the intermediary server and requests a connection to a destination server through this secure link. The intermediary server transforms the request into a normal Internet request and sends it to the destination server on a “stream” basis. Destination responses are transformed where necessary to force any external links and references to be via the intermediary server (using a general process based on the method described with reference to FIG. 2). The transformed responses are also returned to the client on a stream basis.

Using a stream basis the client requests and destination responses are passed/streamed through the intermediary server as they arrive. Advantageously, no extra client or destination server components or changes are required and no client or destination server speed penalties are seen.

Alternative implementations of the method are also envisaged. For instance, it is possible to pass the data through the intermediary server as a “batch” operation as opposed to on a “stream” basis. The intermediary server would wait to transfer certain whole portions of requests and responses instead of as they arrive. To speed up this process, the intermediary site may cache the transformed requests and responses. Also, multi-stage variations could be used where requests and responses are treated as whole or partial files rather than streams with tasks performed on a batched basis rather than a real-time basis which processes the data as it arrives.

It is also possible to include additional components on the client or destination server machines. These components may be for the provision of secure communication capabilities and/or for performing part of the intermediary site procedures on the client or destination server machine. Various optimisations such as compression and securing the intermediary to destination site connection can also be implemented in this manner. It is also possible to alter some client and destination components to remove the need for link and reference transformations. This includes setting the intermediary server as a web browser's Proxy Server. It is also possible to distribute the intermediary server process across several intermediary servers.

Those skilled in the art will appreciate that there are numerous potential implementations within the scope of the invention as described.

We claim:

1. A method affording privacy or anonymity on an Internet-type or other Communications medium, the method comprising:
a) establishing a secure connection between a client and an intermediary site; and
b) offering or providing one or more services through or on the intermediary site to the client.

2. A method as claimed in claim 1, wherein the services include using the intermediary site to forward communications between the client and destination sites so as to prevent one or more of the following:
a) any logging of details of the true destination sites the client has visited by machines capable of monitoring client transactions by means of the secure client-intermediary connection;
b) any logging of the contents of transactions between clients and destination sites by machines capable of monitoring client transactions by means of the secure client-intermediary connection;
c) destination sites finding-out the true origin or location of clients by means of formatting client requests to giving the destination site the impression that the intermediary site was the origin of the communication.

3. A method as claimed in claim 1 or claim 2, wherein the services include one or more of the following:
a) accessing of destination Internet sites by the client through the secure connection with the intermediary site and actively preventing any logging by Internet servers, providers, routers or other machines associated therewith that the destination sites have been visited by the client;
b) sending or receiving e-mails while any logging of either the destination, source or contents of the e-mail is actively prevented;
c) storing files securely on the intermediary site;
d) transferring messages between multiple clients connected through the intermediary as in a secure telephone, conferencing, Internet “Chat”, “Message Board” service or similar.

4. A method as claimed in any one of claims 1 to 3 and further comprising:
a) accessing of destination Internet or Internet-type service sites by the client through the secure connection with the intermediary site; and
b) actively preventing any logging by Internet servers, providers or other machines associated therewith that the destination sites have been visited by the client.

5. A method as claimed in any of the previous claims and further comprising:
a) establishing the secure connection between the client and the intermediary site;
b) allowing the client to use the secure connection to send a request to the intermediary site for forwarding to a destination site;
c) transforming the request into a standard request that can be interpreted by the destination site as originating at the intermediary;
d) sending the transformed client request from the intermediary to the destination site or a proxy for that site;
e) receiving the requested response from the destination site at the intermediary;
f) transforming the destination response into a response identified as being from the intermediary site; and
g) using the secure connection to return the response back to the original client.

6. A method as claimed in claim 5 and further comprising the step of transforming links and references in the response so that any future request made by the client based on the response from the destination site is made by the client through the intermediary site not directly to the destination site.

7. A method as claimed in any one of claims 1 to 6 and further comprising the intermediary site checking that a client connection remains open to the intermediary throughout a communication transaction so that destination responses can be delivered to the client and that the client is not attempting an anonymous denial of service attack on the destination site.

8. A method as claimed in any one of claims 1 to 5 and further comprising:
a) sending or receiving e-mail by the client through the secure connection with the intermediary site; and
b) actively preventing any logging by Internet servers, providers, routers or other machines associated therewith of details of the client, e-mail content, recipients and sender.

9. A method as claimed in any one of claims 1 to 5 and further comprising sending or retrieving a file by the client through the secure connection with the intermediary site and the intermediary site securely storing or retrieving the file.

10. A method as claimed in claim 9, wherein the intermediary site itself stores the file.

11. A method as claimed in any one of claims 1 to 10 and actively hindering Internet transaction sniffing.

12. A method as claimed in any one of claims 1 to 11, wherein the secure connection is an encrypted connection.

13. A method as claimed in claim 12, wherein the encrypted connection is an SSL connection.

14. A method as claimed in any one of claims 1 to 13 used to allow communication with destination sites where the client is restricted from directly accessing the destination site by a restrictive Internet firewall, proxy server, physical limitations or other apparatus.

15. A method as claimed in any pervious claim comprising the intermediary listening for client requests on Internet port numbers above 1023.

16. A method as claimed in any one of claims 1 to 15 and adapted to improve the efficiency and speed of communication transactions by either:
a) adding compression to the client-intermediary connection
b) utilising a rapid communications channel between the client and the intermediary so as to reduce overall round-trip or delay times between the client and ultimate destination

17. A method substantially as herein described with reference to FIGS. 1 to 3 of the accompanying drawings.

18. Use of any of the methods of claims 1 to 17.

19. Apparatus configured to perform any one of the methods of claims 1 to 18.

20. Means to perform any of the methods of claims 1 to 18.
